(19) United States
(12) Patent Application Publication
(10) Pub. No.: US 2011/0141905 A1
(43) Pub. Date: Jun. 16, 2011

(54) Method, Mobile Device and Communication System to Determine the Type of a Network Node

(76) Inventors: Hai Jiang, Beijing (CN); Jian Feng Kang, Beijing (CN); Xiao Yi Wang, Beijing (CN); Chao Wei, Beijing (CN); Yi Wu, Beijing (CN); Dong Mei Zhang, Beijing (CN)

(21) Appl. No.: 13/002,914

(22) PCT Filed: Jul. 9, 2008
(86) PCT No.: PCT/EP2008/058911

§ 371 Date: Feb. 16, 2011

(51) Int. Cl. H04L 12/26

(52) U.S. Cl. 370/241

(57) ABSTRACT

A network node, a mobile device, a communication system, a method for detecting the type of a network node, the method for transmitting the type of a network node and the use of a data frame for determining the type of a network node is described. To distinguish between different types of network nodes, a signal pattern including an attribute is transmitted/received. The attribute is type-indicative of the type of the network node. Different ways of implementing the type-indicative attribute are described.

### TECHNICAL FIELD OF THE INVENTION

The present invention relates to wireless communication in general. More particularly, it relates to a network node, a mobile device for determining the type of a network node, a communication system, a method for determining the type of a network node, a method of transmitting the type of a network node, a computer readable medium, a program element and the use of a frame for determining the type of a network.

In particular, it relates to the detection and determination whether a network node is of femto network node type/femto base station type or macro network node type/macro base station type.

### BACKGROUND OF THE INVENTION

Mobile communication has significantly changed our way of living over the past two decades. 20 years ago, it was common for a caller who tried to reach a specific person, to just call the fixed line of that person and, in case the person is not available, left a message on the answering machine of that person.

Nowadays, it is not uncommon to have one or maybe even multiple possibilities to reach a person wirelessly, without the need of that person to be at a specific point at a given time, for example at home.

Wireless communication made it possible to reach everybody almost everywhere, almost all the time. So, with advancements of mobile communication technology the limiting factor of reaching one's desired person, limitations now have to be looked for in the technical area.

Even with the newest mobile communication devices, without proper aerial coverage, it is difficult to reach somebody at the desired time.

Such limitations may be for example that the person itself is travelling in a region with no or at least rudimentary wireless communication coverage. Equally, the problem of not reaching someone may be as simply as that the person, though being within an area with sufficient wireless coverage, is presently situated in a place where the wireless coverage is obstructed for example by architectural means like being in a cellar or basement or even within a high-rise building, where the materials used for building said structure interfere with or prohibit wireless communication. For example, the use of high-density concrete or metal reinforcement in wall structures may be a reason for a wireless communication device not being able to function properly.

On the other hand, even if there is sufficient coverage, the callee might decide as well to switch off his mobile communication device, simply because of the still inherent costs associated with operating and maintaining a mobile device, even when only receiving a communication.

Following, it may be desirable to either provide enhanced means for providing wireless communication coverage as well as providing alternative ways of mobile communication with increased coverage and/or reduced costs for mobile communication.

One such solution may be the use of a so-called femto cell mobile base station/a femto type network node.

A femto base station may be best explained as a “private communication node” connecting a mobile wireless communication device with the communication network of a communication provider by using an already existing communication infrastructure, like for example an already existing internet connection, thus reducing the cost of wireless communication as opposed to the use of a macro base station, said macro base station being directly connected to the communication network of and operated by a mobile communication provider.

In the latter case, the user of a mobile communication network would have to pay high communication costs as dictated by the mobile communication provider wherein in the first case, the femto base station uses an existing infrastructure, like for example the Internet, to bridge the path between the femto base station and the network of the wireless communication provider, thus reducing or even waiving/removing the cost associated with mobile communication, at least to some degree.

A mobile communication device may not be able to differentiate between femto base stations and macro base stations.

In document IEEE 802.16 (IEEE Std. 802.16e-2005 and IEEE Std. 802.16-2004/Cor1-2005—Feb. 26, 2006) a frame is disclosed.

A frame may be considered to be at least a part of a broadcast signal e.g. from a cellular network. A preamble and a frame control header may be part of the information from the broadcast signal included in each frame.

The WiMAX or IEEE 802.16e frame structure, the preamble pilot modulation and the frame control header repetition are disclosed in the IEEE 802.16e standard.

### SUMMARY OF THE INVENTION

There may be a need to distinguish between a femto base station and a macro base station.

Thus, a network node, a mobile device, a communication system, a method for detecting the type of a network node, a method for transmitting the type of a network node, a computer-readable medium, a program element and the use of a frame for determining the type of a network node according to the independent claims.

According to an exemplary embodiment of the present invention, a network node is provided, comprising a receiving and transmitting unit, wherein the receiving and transmitting unit is adapted to transmit a signal pattern comprising an attribute and wherein the attribute is indicative of the type of the network node.

According to another exemplary embodiment of the present invention, a mobile device (or mobile station) for determining the type of a network node is provided, the mobile device comprising a processing unit and a receiving and transmitting unit, wherein the receiving and transmitting unit is adapted to receive a first signal pattern comprising a first attribute from a first network node, the first attribute being indicative for the type of the first network node and wherein the processing unit is adapted to evaluate the received first attribute for determining the type of the first network node.

According to another exemplary embodiment of the present invention, a communication system is provided, comprising a first network node according to the present invention, a second network node and a mobile device according to the present invention, connectable to the first and/or the second network node.

According to another exemplary embodiment of the present invention, a method for detecting the type of a network node is provided, the method comprising receiving a first signal pattern from a first network node, the first signal pattern comprising a first attribute being indicative for the type of the first network node, evaluating the received first attribute and determining the type of the first network node.

According to another exemplary embodiment of the present invention, a method of transmitting the type of a network node is provided, comprising sending a signal pattern comprising an attribute, the attribute being indicative of the type of the network node.

According to another exemplary embodiment of the present invention, a computer-readable medium is provided comprising program code, which program code is adapted, when being executed by a processor, to carry out the method for detecting the type of a network node and the method of transmitting the type of a network node.

According to another exemplary embodiment of the present invention, a program element is provided, comprising a program, which program is adapted, when being executed by a processor, to carry out the method for detecting the type of a network node and the method of transmitting the type of a network node.

A computer-readable medium may be a floppy disk, a CD-ROM, a DVD, a harddisk, a USB (Universal Serial Bus) storage device, a RAM (Read Access Memory), a ROM (Read Only Memory) and an EPROM (Erasable Programmable Read Only Memory).

A computer-readable medium may also be a data communication network, e.g. the Internet, which allows downloading a program code.

According to another exemplary embodiment of the present invention, the use of a frame for determining the type of a network node is provided, the frame comprising a type-indicative attribute, wherein the type-indicative attribute is one out of the group consisting of a type-indicative preamble of a frame, a type-indicative flag of a frame and a type-indicative polarity sequence in the frame control header repetition.

In telecommunications, a femto cell, also known as an access point base station, may be a small cellular base station. This small cellular base station may be connecting to a mobile communication provider's network via a broadband communication connection, like for example the Internet (e.g. implemented by a DSL or cable connection) and may be used in residential or small business environments. Current designs may support up to 5 mobile communication devices in a typical residential setting.

On the other hand, a femto cell may enable the mobile communication provider to extend its wireless communication coverage indoors, where wireless communication coverage would otherwise be limited or even unavailable.

A femto cell may be basically a typical base station, which is not connected to the communication network of the wireless communication provider but is rather using an independent communication infrastructure, for example the Internet, to connect to the network of the mobile communication provider.

The technology for accessing a femto cell with a mobile communication device may be any standard of, for example UMTS, GSM, CDMA-2000, TD-SCDMA and WiMAX. However, the use of other mobile communication standards may be conceivable as well.

The concept of a femto cell is simple: Make a base station cheap enough to be deployed in high volume for residential use, connected to the core network of a communication provider via an already existing broadband connection.

This may deliver a subscriber the same service and benefit as a regular macro base station, installed and maintained by the wireless communication provider, however providing mobile services to a user with high data throughput and/or better coverage as opposed to the regular macro base station, in case the mobile communication device used by the user is located within the femto cells coverage area.

Furthermore, it is also conceivable to have a pricing system for a communication using a “private” femto cell, which is different from that of macro cell communication depending on the business models of a wireless communication provider. For example, a monthly flat fee for each femto cell at home or small office may be possible.

During handover, it may be useful to differentiate between a femto base station and a macro base station. If both a femto base station and a macro base station are available from a target base station list, connection to a femto base station may be preferred over connection to a macro base station.

In the following, further embodiments of the present invention are described referring in particular to a network node, a mobile device for determining the type of a network node, a communication system, a method for detecting the type of a network node, a method of transmitting the type of a network node, a computer-readable medium, a program element and the use of a data frame for determining the type of a network node.

However, arbitrary variations and interchanges of single or multiple features between the claimed entities is conceivable and within the scope of the present patent application.

According to an exemplary embodiment of the present invention, the network node may be connectable to a communication network and may be adapted to provide a signal exchange between the receiving and transmitting unit and the communication network.

The network node may be operating in a bridging operation mode, thus connecting the wireless communication devices in communication with the network node with a communication network. The communication network may be, for example, the Internet through which a communication channel to a communication provider may be established.

Thus, the network node may be forwarding received data, received at either the receiving and transmitting unit or through the communication network to the respective other side. A special encoding, recoding or reformatting procedure of the received data before forwarding to the other communication port may be conceivable. Also, encryption, authentication or other security measures may be employed.

The network node may act completely transparent, thus on a separate communication layer, so neither a mobile communication device connected to the receiving and transmitting unit and the communication network or the communication provider connected via said communication network may recognize the existence of the network node.

In other words, a transparent operation of the network node may mean that the network node may evaluate header information of a frame without interpreting the content or payload of the frame.

According to a further embodiment of the present invention, the network node may be a femto base station.

A femto base station may be a small, low cost cellular base station for providing indoor coverage.

The power consumption of a femto base station or femto CPE (customer premises equipment) may be less than 100 W. A femto base station may have a 230V or 110V AC power system.

The signal strength of an corresponding femto base station may be lower than the signal strength of a regular base station (i.e. macro base station or pico base station), thus may reduce the exposure to electromagnetic radiation.

A femto base station may have a coverage of approximately 50 m, 0-50 m or 0-100 m or the like, which may constitute a reduced coverage area.

Furthermore, due to employing a privately and/or already existing communication network, the use of a femto base station for connecting to a communication provider may reduce the costs for using the communication service of that communication provider and/or may even increase data transfer rates or bandwidth allocated to said communication.

According to a further embodiment of the present invention the network node is operating according to at least one standard of the group consisting of 3rd Generation standard (3G), 3rd Generation Partnership Project standard (3GPP), Universal Mobile Telecommunications System standard (UMTS), Worldwide interoperability for Microwave Access standard (WiMAX), Long-Term Evolution standards (LTE), Global System for Mobile Communication standard (GSM) and IEEE 802.16 standard.

The use of an already existing standard, whereby the aforementioned standards are not to be taken limiting, may facilitate the implementation of a femto base station.

Using an already existing standard, in particular using a frame according to a standard, may even allow for a bridging operation between a mobile communication device and the network of a communication provider, without specifically having to adapt the operation mode of a base station to either the communication network or the mobile communication device.

Furthermore, the use of a so-called “dual mode” (operating in two (different) modes or according to two (different) standards) or newly developed mobile communication devices may be prevented, thus allowing to use already existing technology and devices and so allowing the use of already existing technology for communicating with an inventive network node). Thus, the replacement cost of already existing communication devices may be reduced.

According to a further embodiment of the present invention, the attribute is a preamble of a frame.

In communication schemes, the communication may be implemented by using a repeating data structure.

One self-contained element of the communication data structure may be a so-called frame or a so-called packet. A frame or packet may comprise different elements within the frame or packet.

Some elements may indicate the data format, encoding, decoding and/or encryption or decryption schemes, means for detecting and/or synchronizing to the communication or data stream may be present and data, both in downlink and uplink direction.

A frame may comprise a preamble. A preamble may be part of a header of a frame and may be a sequence of signals, which sequence as a whole contains information, which may be exchanged.

One application of a preamble may be to allow a communication device to detect a communication transmission and to synchronize itself to the transmission for receiving and sending of data.

The preamble may be used for differentiation among different macro base stations. To differentiate a femto base station and a macro base station, some preamble may be reserved for a femto base station type. Thus, the mobile device may differentiate the femto base station or femto network node from the macro base station or macro network node.

According to a further embodiment of the present invention the attribute may be a flag of a frame.

Other parts of the frame, may comprise a so-called flag. A flag may be used for indicating specific conditions.

A flag may be considered to be a single bit or a (defined) sequence of bits of a communication used for indication and signaling of said conditions.

For example, an unused and/or even reserved bit or sequence of bits within a part of the communication data stream or frame may be employed for the signaling of the type of the base station.

Thus, by interpreting the setting of the flag, a determination and/or distinguishing of a femto base station as opposed to a different type of base station may be conducted.

Such a flag may be situated or located in a predefined position within the frame, in particular it may be situated in the frame control header part, even more particularly within a special data structure of the frame control header.

A flag may be set in the frame control header block, which may be following the preamble as designed by the IEEE 802.16e standard.

According to a further embodiment of the present invention, the attribute may be a polarity sequence in the frame control header repetition.

Repetition coding may be a (n,1) coding scheme that repeats bits across a channel to achieve error-free communication. A (n,1) coding scheme may mean that for each bit which shall be transmitted, n bits are identically transmitted. For example, with a (4,1) repetition coding, each bit may be identically repeated four times in preparation to sending.

In repetition coding, each repeated element or bit may feature the same polarity, thus allowing a majority decision. In case a bit was transmitted errorously and the polarity of the bit was changed, within the communication data stream, the majority decision may allow to decode the polarity of the bit as sent.

In order to indicate a femto base station, a defined alteration of the polarity sequence may be used in repetition coding, e.g. the bit may be repeated using an alternating prefix.

For example, the repetition form of the frame control header may be changed from [A A A A] to [A −A A −A] for a femto base station or femto network node. According to the IEE 802.16e standard, the repetition form of the frame control header blocks may be [A A A A] for a macro base station or macro network node.

According to a further embodiment of the present invention, the receiving and transmitting unit of the mobile device may be further adapted to receive a second signal pattern comprising a second attribute from a second network node, the second attribute being indicative for the type of the second network node and the processing unit of the mobile device is adapted to evaluate the received second attribute for determining the type of the second network node.

By receiving a first signal pattern comprising a first attribute and a second signal pattern comprising a second attribute and subsequently evaluating the signal patterns may allow determining which signal pattern or which attribute belongs to which type of network node. Different types of network nodes may be a femto base station or a macro base station. It may be possible to determine the type of each of the network nodes. After determining the type of a network node the mobile device may connect to the network node, i.e. the network node having the preferred type.

For example, if a signal pattern comprising an attribute indicating the presence of a femto base station is received as well as a further signal pattern comprising a further attribute indicating the presence of a regular or macro base station, the connection to the femto station may be preferably established, due to the possibility of higher bandwidth and/or reduced costs for communications.

According to a further embodiment of the present invention, the mobile device may be adapted to connect to at least one of the first network node and the second network node for transmitting communication data depending upon the determined type of the first and of the second communication node.

Since the mobile device may be able to distinguish the types of the network nodes, the mobile device may connect to a network node of preferred type.

After connecting to a network node, transmission of communication data may be possible. Further, it may be possible to alter the communication and/or the parameters of communication according to the determined type of the network node, alternatively, the transmission of communication data may even be independent from the determined network node type, thus allowing for a completely transparent communication after connecting to the network node.

According to a further embodiment of the present invention, determining the type of the first and of the second network node may comprise one of the group consisting of evaluating a type-indicative preamble of a frame, evaluating a type-indicative flag of a frame and evaluating a type-indicative polarity sequence in the frame control header repetition.

According to a further embodiment of the present invention, one of the first network node and the second network node of the communication system may be of femto base station type, wherein the other network node may be of macro base station type.

In such a communication system connecting to a preferred base station type may be possible, for example to a femto base station if a mobile communication device is located within a communication range of both a femto base station and a macro base station.

A communication system may allow for a communication in an area serviced by the macro base station (i.e. an area being larger that that serviced by a femto base station) whereas in the of vicinity of the femto base station, communication may be established via said femto base station, thus allowing for alternative communication conditions like for example reduced cost and/or enhanced bandwidth.

According to a further embodiment of the present invention, the first and the second network node of the communication system may be connected to a communication network.

If the network nodes are connected to a communication network, a communication between a mobile station and the communication network or another user may be possible by using said network nodes.

The network nodes may be used as base stations and/or as transparent bridges, in order to connect a mobile communication device and a corresponding communication network.

According to a further embodiment of the present invention, the method for detecting the type of a network node may further comprise receiving a second signal pattern from a second network node, the second signal pattern comprising a second attribute being indicative for the type of the second network node, evaluating the received second attribute and determining the type of the second network node.

According to a further embodiment of the present invention, the method may further comprise connecting to at least one of the first and of the second network node for transmitting communication data depending upon the determined type of the first and of the second network node.

According to a further embodiment of the present invention, each of the first and of the second network node is a base station of a wireless network.

According to a further embodiment of the present invention, the first network node and/or the second network node is of femto base station type.

According to a further embodiment of the present invention, the other network node is of macro base station type.

According to a further embodiment of the present invention, determining the type of the first and/or of the second network node may comprise one of the group consisting of evaluating a type-indicative preamble of a frame, evaluating a type-indicative flag of a frame and evaluating a type-indicative polarity sequence in the frame control header repetition.

It has also to be noted that embodiments of the present invention and aspects of the invention have been described with reference to different subject-matters. In particular, some embodiments have been described with reference to apparatus type claims whereas other embodiments have been described with reference to method type claims or use type claims. However, a person skilled in the art will gather from the above and the following description that unless other notified in addition to any combination features belonging to one type of subject-matter also any combination between features relating to different subject-matters in particular between features of the apparatus claims and the features of the method claims or use claims is considered to be disclosed with this application.

These and other aspects of the present invention will become apparent from and elucidated with reference to the embodiments described hereinafter.

Exemplary embodiments of the present invention will be described in the following with reference to the following drawings.

### BRIEF DESCRIPTION OF THE DRAWINGS

FIG. 1 shows an exemplary embodiment of a network node according to the present invention,

FIG. 2 shows an exemplary embodiment of a mobile device according to the present invention,

FIG. 3 shows an exemplary embodiment of a communication system according to the present invention,

FIG. 4a,b show an exemplary flow-chart of the methods for detecting and transmitting the type of a network node according to the present invention,

FIG. 5 shows an exemplary frame structure of a frame according to IEEE 802.16 standard,

FIG. 6 shows an exemplary implementation of the DL_frame_prefix_format of a frame control header according to FIG. 5.

### DETAILED DESCRIPTION

The illustration in the drawings is schematic. In different drawings, similar or identical elements are provided with the same reference numerals.

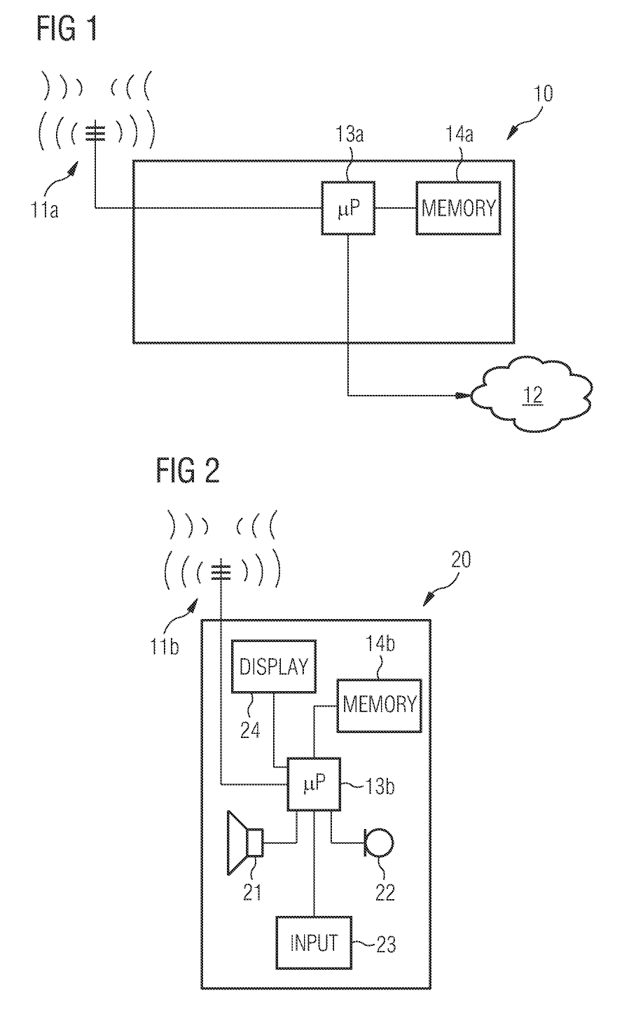

Now referring to FIG. 1, an exemplary embodiment of a network node 10 according to the present invention is depicted.

The network node 10 has a receiving and transmitting unit 11a, in this case an antenna for receiving and transmitting electromagnetic waves. However, different transmission types are conceivable like for example a direct cable connection, IR or the like.

The receiving and transmitting unit 11a is connected to a microprocessor 13a with a memory 14a attached to the microprocessor 1a. The microprocessor 13a is adapted to process data or information received by the receiving and transmitting unit 11a and to provide information or data to be transmitted through the receiving and transmitting unit 11a. Data received or to be transmitted is stored, temporarily or permanently, in the memory 14a.

A further connection to a second communication network 12 is depicted as well. This connection is capable of receiving and/or transmitting information or data from and to the communication network 12. The communication network 12 may be attached via standardized means like for example a LAN, Ethernet port commonly used in IT systems.

However, different types of connections may be employed like for example a similar second receiving and transmitting unit 11a for wireless communication.

The network node may be operating in a completely transparent mode (state), after the connection of a mobile device 20 (not depicted) via the receiving and transmitting unit 11a to the network node 10.

It may also be conceivable that the network node 10 acts transparent to any incoming and outgoing transmission of any kind between the mobile device 20, connected to the network node via receiving and transmitting unit 11a and the communication network 12.

Encoding, decoding, recoding, encryption and/or decryption necessary for the communication may be performed by the microprocessor 13a as well. The network node 10 may be powered by a separate power supply (not depicted), via the interface used for connecting the communication network (e.g. with a power-over-Ethernet capability) or may even function passively, i.e. without any external power input.

The network node 10 may utilize for its communication through the receiving and transmitting unit 11a and/or the interface to the communication network 12 any kind of wireless or wired communication standard like for example 3G, 3GPP, UMTS, WiMAX, LTE, GSM and IEEE 802.16. The connection may even be standardized WLAN connection as commonly used in IT systems and infrastructure.

The network node may detect whether the network node is employed in a femto base station type environment or as a macro base station. A corresponding mode of operation may be set remotely via any of both ways of interfacing with the network node 10, i.e. via the receiving and transmitting unit 11a and through the communication network 12.

The network node 10 may optionally sense the necessary mode of operation. For example when connected to a private Internet connection, the network node may operate as a femto base station, whereas when connected to the infrastructure of a communication provider, the network node may operate as a macro base station.

This way, an identical network node may be employed by both “private user” and the “corporate user”, thus reducing interoperability problems as well as cost of manufacture.

Necessary authentication, encryption and/or decryption of the communication over the receiving and transmitting unit 11a and to the communication network 12 may be carried out by the processor 13a as well.

The network node 10 may employ any of the type-indicative attribute that will be described in further detail later, like for example a preamble of a frame, a flag of a frame and a polarity sequence in the frame control header repetition.

Now referring to FIG. 2, a mobile device 20 for communicating with the network node 10 according to the present invention is depicted.

It is to be understood that all processing, encoding, decoding, encryption and/or decryption and all communication standards as elaborated on regarding the network node 10 above may apply to the mobile device 20 as well.

Here, the sending and receiving unit 11b of the mobile device 20 operates in a comparable way to the sending and receiving unit 11b of the network node 10.

The mobile device 20 comprises a microprocessor 13b and a memory 14b attached to the microprocessor 13b. The microprocessor 13b is adapted for receiving, transmitting, short-term or long-term storing signals, for encoding, decoding, encrypting, decrypting information and/or authenticating of user.

Furthermore, since the mobile device 20 may be intended to be used by a person for communicating, a loudspeaker 21 and a microphone 22 are depicted, both attached to the microprocessor 13b. Necessary encoding and decoding of voice and/or sound transmissions may be performed by the microprocessor 13b as well.

Furthermore, an input device 23 is depicted in FIG. 2, attached to the microprocessor 13b. The input device 23 may be a numerical or alphanumerical keyboard for typing in information like for example a phone number or a web address.

However, the input device 23 may be any kind of possible input device like for example a speech recognizing device, a barcode scanner or the like or even a device for further communication like for example receiving and transmitting unit 11b or a device for connecting a further communication network 12.

The main difference between the network node 10 and the mobile device may be that of the further attachment of speaker 21 and microphone 22 to the mobile device 20 as opposed to the network node 10.

Thus, the network node 10 and the mobile device 20 may use identical receiving and transmitting units 11a,b, identical microprocessors 13a,b and/or the identical memory 14a,b.

The mobile device 20 may receive multiple incoming transmissions from different types of network nodes 10. Thus, the need may arise for the mobile device 20 to distinguish different types of network nodes in its vicinity. By determining the type of the network nodes 10 in its vicinity, the mobile device 20 may choose a preferred type of network node, e.g. a femto base station type network node.

An according femto base station type may employ significantly reduced signal strength, thus reducing exposure to electromagnetic waves, as well as reducing cost for the communication and/or enhancing bandwidth.

The mobile station 20 may receive different signally of different network nodes in its vicinity and may evaluate the received signal patterns comprised in the signal of all receivable network nodes. Thus, the respective attributes embedded within the respective signal patterns of the respective network nodes are received by the mobile device 20 and the mobile device 20 decides according to a predetermined set of rules to which network node 10 the mobile station 20 connects to.

It may also be possible for the mobile device 20 to signal to the user how many and what type of network nodes 10 are currently available via a display 24, connected to the microprocessor 13b.

The display 24 may be any kind of display, like for example liquid crystal display (LCD), a simple light emitting diode (LED) display or indicator or the like.

The display 24 may even be touch-sensitive, thus it may be possible to incorporate the display 24 and the input device 23 within the same unit.

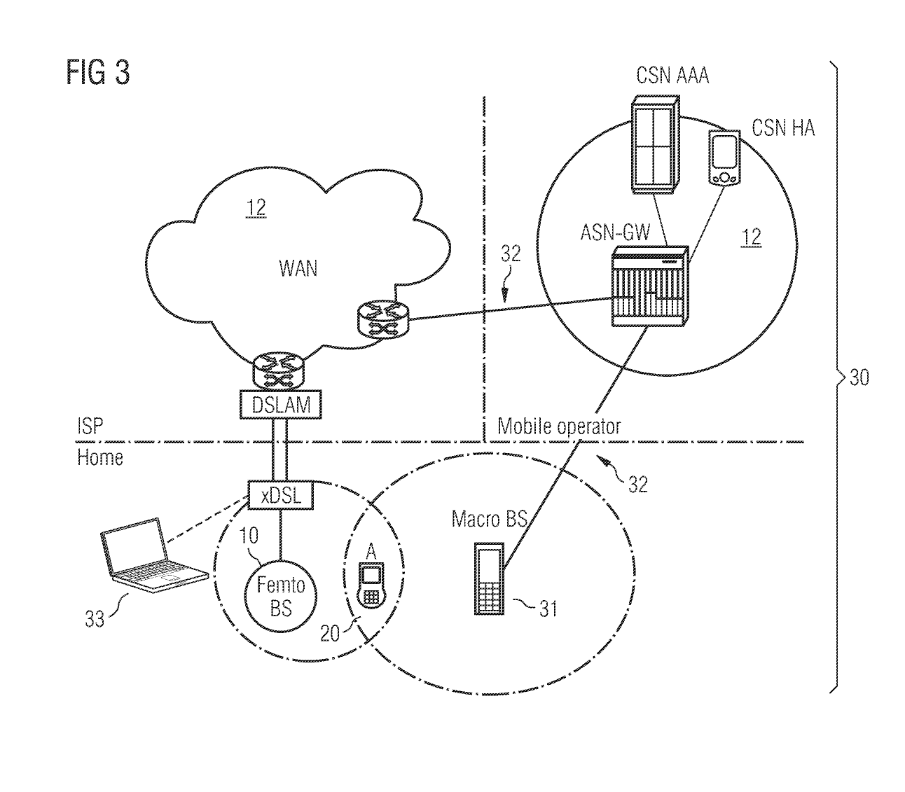

Now referring to FIG. 3, an exemplary embodiment of a communication system according to the present invention is depicted.

In FIG. 3, three different areas or regions may be distinguished. A user is operating a mobile device 20 in the region of his or her home. The user has a private DSL (digital subscriber line) connection connected via a DSLAM (Digital Subscriber Line Access Multiplexer) to the communication network of an Internet service provider and thus to the Internet.

Connected to the DSL connection is a laptop 33 or any type of computer device 33 utilizing e.g. a standardized Ethernet port. Furthermore, a femto base station 10 is connected to the DSL connection of the user to the Internet service provider.

The mobile device 20 may connect to femto base station 10, thus providing a (transparent) connection via the DSL connection to the Internet/communication network 12 of the Internet service provider.

The home connection to the Internet service provider may be any kind of connection like for example a xDSL (ADSL, SDSL), very high speed DSL (VDSL), cable connection, direct Ethernet connection or a fibre optical connection. Even a common dial-up connection (analog or digital (ISDN—Integrated Services Digital Network)) or a direct connection to the mobile operator from the home of the user is conceivable.

Furthermore, somewhere in the vicinity of the home of the user a macro base station 31 is installed by the mobile operator. The macro base station 31 enables anyone within the vicinity of the macro base station 31 to connect to macro base station 31 and following via the communication link 32 to the communication network 12 of the mobile operator.

The mobile operator is utilizing in the exemplary embodiment of FIG. 3 an access service network gateway (ASN-GW) to connect to the communication network via the link 32 to the WAN (Wide Area Network) of an ISP (Internet Service Provider).

A connectivity service network authentication server (CSN AAA) and a connectivity service network home agent (CSN HA) are also depicted In FIG. 3.

The mobile device 20 is able to connect to both the femto base station 10 and the macro base station 31. Since a connection via the femto base station 10 may provide multiple advantages like for example reduced cost of communication and/or increased bandwidth, the connection to the femto base station 10 by the mobile device 20 may be preferred. Increased bandwidth may allow high data transmission rates.

Both the femto base station 10 and the macro base station 31 however, are equally accessible. Thus the mobile device 20 utilizes the type-indicative attribute of both the communication of the femto base station 10 and the macro base station 31 to distinguish and/or to determine the type of each base station 10,31.

The mobile device 20 knows, that both a femto base station 10 as well as a macro base station 31 is within its vicinity, thus it may choose to connect to the femto base station 10.

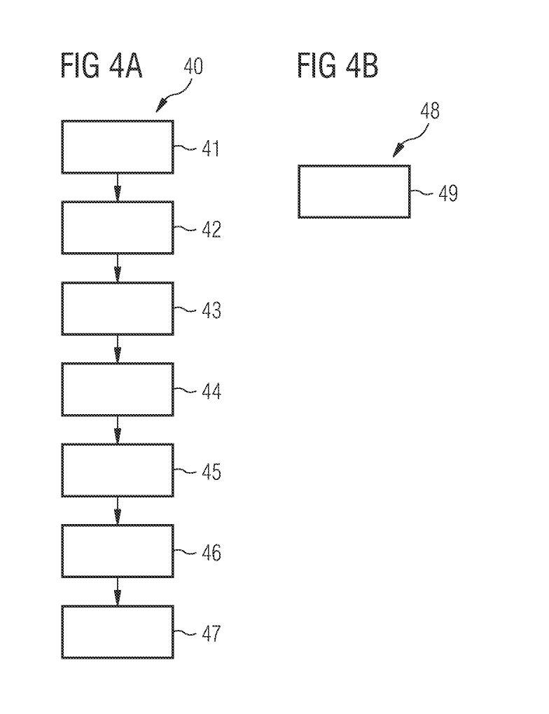

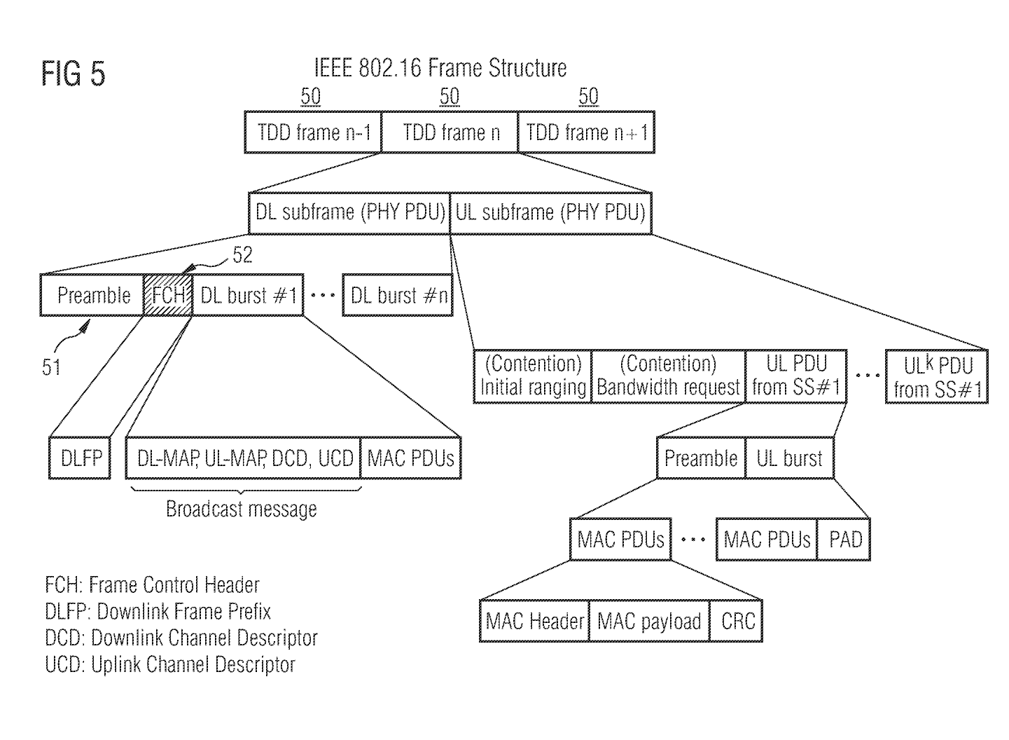

Now referring to FIG. 4a, a method for detecting the type of a network node 40 according to the present invention is depicted.

The sequence of the method steps illustrates one particular implementation of the method according to the present patent application, removal, omission or restructuring of steps is within the scope of the present patent application.

In a first step, a first signal pattern from a first network node is received 41, the first signal pattern comprising a first attribute being indicative for the type of the first network node.

In a next step 42, the first signal pattern and/or the first attribute is evaluated 42 and subsequently the type of the first network node is determined 43.

In step 44, a second signal pattern from a second network node is received. The second signal pattern comprises a second. Subsequently, the received second attribute and/or the second signal pattern is evaluated 45 and the type of the second network node is determined 46.

In case a third or a plurality of network nodes are in the vicinity of the network node 10 the steps 41 to 43 and/or 44 to 46 may be repeated until all reachable, connectable network nodes are evaluated and their type determined.

When the type of all network nodes 10 is determined, the mobile device 20, in step 47, may connect to at least one of the detected and determined network nodes 10 for subsequent communication and transmission of communication data.

In case multiple femto type network nodes 10 are detected, the mobile device may choose anyone of them for subsequent communication and transmission of communication data, or may be instructed to connect to a specific one, for example the personal one of the user of the mobile device 20.

It is also conceivable that the mobile device 20 keeps on repeating steps 41 to 43 and/or 44 to 46 until at least one femto base station type network node is detected and the mobile device 20 is authorized to connect to that detected femto type network node.

In this case, even if more network nodes are available the determination of the type of the network nodes only has to be carried out until one connectable femto base station type network node 10 is detected/determined.

Now referring to FIG. 4b, a method of transmitting 48 of a network node 10 according to the present invention is depicted.

### An Attribute May Determine the Type of a Network Node

The method comprises the step of sending a signal pattern 49 comprising an attribute, the attribute being indicative of the type of the network node 10.

The type-indicative attribute is one out of the group consisting of allocating a type-indicative preamble to a frame, setting a flag of a frame and employing a polarity sequence in the frame control header repetition.

The method may be carried out by the network node permanently, until a connection is established or in case multiple connections are possible, until all possible connections are established.

The repetition of the method may be at predetermined time intervals like for example one in every ms, one in every tenth of a second, every second, every 10 second and the like.

Both the method of detecting 40 the type of a network node and the method of transmitting 48 the type of a network node may be incorporated on a computer-readable medium as program code and/or a program element comprising a program, both the program code and the program being adapted, when being executed by a processor, to carry out at least some of the method steps depicted in FIGS. 4a and b.

The proposed methods are to differentiate femto type network nodes 10 from macro type network nodes 31 in different ways, so that a mobile device 20 may access, detect, distinguish and/or connect to a femto type network node 10 selectively.

While the mobile device 20 initially accesses a network, trying to establish a network connection, it may listen to the preamble and/or the frame control header broadcasted from an arbitrary network node 10,31.

For example, if multiple preamble signals are detected that are equally strong or strong enough within a certain range for the mobile device to connect to, the mobile device 20 may desire to selectively connect to a femto type network node 10 rather than a macro type network node 31 to for example enjoy pricing benefits and/or higher data transfer rates.

During a possible handover when leaving and/or entering a cell, the same rule may be followed.

If both a femto type network node 10 and a macro type network node 31 are available from a target network node list (a list of all available and/or connectable network nodes in the vicinity of the mobile device 20), a mobile device 20 could preferably handover to a femto type network node 10 instead of a macro type network node 31 due to the aforementioned advantages.

This determination of the type of the network node may be implemented in various ways. For example, a different preamble may be allocated to a femto type network node 10 and a macro type network node 31.

FIG. 5 depicts a typical IEEE 802.16 frame structure with three consecutive frames 50. Each frame contains a downlink subframe and an uplink subframe part. The downlink subframe part is divided into a preamble area 51, a frame control header 52 (FCH), the FCH containing the downlink frame prefix (DLFP), and multiple downlink burst sequences 1 to n.

A detailed description of the WiMAX or IEEE 802.16e frame structure may be found the IEEE 802.16e standard.

In IEEE 802.16e standard, there are 114 preamble modulation series per segment and IDcell (in 1024-FFT (Fast Fourier transform) mode). A certain amount of preamble modulation series may be allocated to a femto type network node 10 whereas other preamble modulation series may be allocated to a macro type network node 31.

For example, an allocation of IDcell={30,31} and segment={0,1,2} may be allocated to the preamble in case the network node is of femto type. The detection of an according preamble may signal to the mobile device 20 that the detected network node is of femto type.

Furthermore, it may be conceivable to utilize a flag in the frame control header 52 to identify a femto type network node 10.

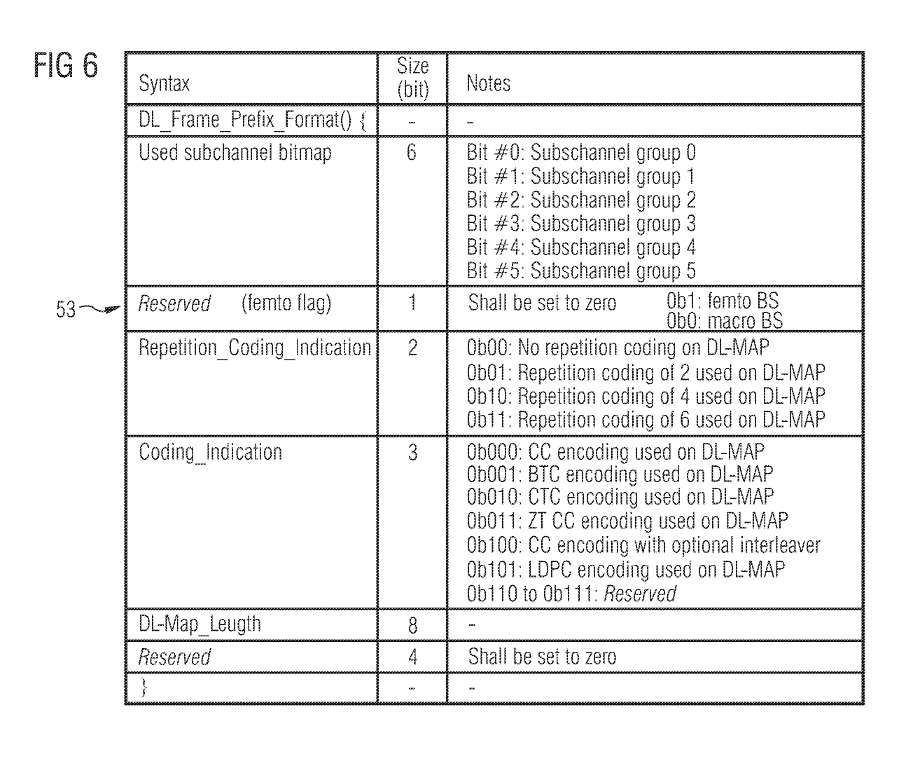

In FIG. 6, the data format of the data structure DL_frame_prefix, that is transmitted at the beginning of a frame according to FIG. 5, is depicted. This data structure contains information regarding the current frame and is mapped to the frame control header. An exemplary embodiment of the structure of the DL_frame_prefix may be taken from FIG. 6.

The data structure contains multiple groups of bits to signal information about the current frame like for example the used subchannel bitmap, the used repetition coding and the coding indication.

The reserved flag 53 may be utilized to signal the type of the network node. For example, it may be set to “0” (the reserved, standardized setting) for indication of a macro type network node 31 or may be set to “1” indicating a femto type network node 10.

However, the data structure of FIG. 6 can only be used to identify the type of the network node after synchronizing with a network node. Depending on the set flag 53, the mobile device 20 may subsequently decide whether to access the identified network node depending on the defined policy.

Furthermore, it is also conceivable to employ a polarity sequence in the frame control header repetition to identify the type of the network node.

Typically the first four slots in the downlink part of the segment contain the frame control header.

In WiMAX standard, these slots may be modulated by using QPSK (Quadrature Phase Shift Keying) with a coding rate of and a repetition coding of 4. To add more information in the frame control header, polarized repetition may also be employed.

Repetition coding is a (n,1) coding scheme that repeats the bits across a channel to achieve error-free communication. The encoder simply repeats, n times, a particular bit to a waveform modulator when the bit is received from the source stream.

Repetition decoding is done using a majority logic detection. For example, for a macro type network node 31a repetition may be defined as [A A A A]. This means, that a bit or sequence of bits is identically repeated n (here 4) times, i.e. with same polarity or prefix.

For a femto type network node 10, the repetition form may be changed to [A −A A −A] with the second and fourth part having an inverted polarity, thus changed or inverted prefix

Thus, by utilizing an according polarisation sequence, the type of network node may be indicated, transmitted and subsequently determined.

A detailed description of the preamble modulation may be found in the IEEE 802.16e standard.

The detailed description of the frame control header repetition may be found in the IEEE 802.16e standard.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

### LIST OF REFERENCE NUMBERS

10 Network node
11a,b Receiving and transmitting unit
12 Communication network
13a,b Processing unit/microprocessor
14a,b Memory unit
20 Mobile device
21 Speaker
22 Microphone
23 Input unit
24 Display
30 Communication system
31 Second network node
32 Link
33 Computer/Laptop
40 Method for detecting the type of a network node
41 STEP: Receiving a first signal pattern
42 STEP: Evaluating the received first attribute
43 STEP: Determining the type of the first network node
44 STEP: Receiving a second signal pattern
45 STEP: Evaluating the received second attribute
46 STEP: Determining the type of the second network node
47 STEP: Connecting to at least one of the first and the second network node
48 Method of transmitting the type of a network node
49 STEP: Sending a signal pattern comprising an attribute
50 Frame
51 Preamble
52 Frame control header
53 Reserved flag

1-23. (canceled)

24. A network node, comprising
a receiving and transmitting unit; wherein
the receiving and transmitting unit is adapted to transmit a signal pattern comprising an attribute; and wherein
the attribute is indicative of the type of the network node.

25. The network node according to claim 24, wherein
the network node is connectable to a communication network; and wherein
the network node is adapted to provide a signal exchange between the receiving and transmitting unit and the communication network.

26. The network node according to claim 24, wherein
the network node one entity of the group consisting of a base station of a wireless network and a femto base station.

27. The network node according to claim 24, wherein
the network node is operating according to at least one standard of the group consisting of 3rd Generation Standard, 3rd Generation Partnership Project Standard, Universal Mobile Telecommunications System Standard, Worldwide Interoperability for Microwave Access Standard, Long-Term Evolution Standard, Global System for Mobile Communications Standard and IEEE 802.16 Standard.

28. The network node according to one of the claim 24, wherein
the attribute is a preamble of a frame.

29. The network node according to one of the claim 24, wherein
the attribute is a flag of a frame.

30. The network node according to one of the claim 24, wherein
the attribute is a polarity sequence in a frame control header repetition.

31. A mobile device for determining the type of a network node,
the mobile device comprising
a processing unit;
a receiving and transmitting unit; wherein
the receiving and transmitting unit is adapted to receive a first signal pattern comprising a first attribute from a first network node, the first attribute being indicative for the type of the first network node; and wherein
the processing unit is adapted to evaluate the received first attribute for determining the type of the first network node.

32. The mobile device according to claim 31, wherein
the receiving and transmitting unit is further adapted to receive a second signal pattern comprising a second attribute from a second network node, the second attribute being indicative for the type of the second network node; and wherein
the processing unit is adapted to evaluate the received second attribute for determining the type of the second network node.

33. The mobile device according to claim 31, wherein
the mobile device is adapted to connect to at least one of the first and the second network node for transmitting communication data depending upon the determined type of the first and of the second communication node.

34. The mobile device according to one of the claim 31, wherein
determining the type of the first and of the second network node comprises one of the group consisting of evaluating a type-indicative preamble of a frame, evaluating a type-indicative flag of a frame and evaluating a type-indicative polarity sequence in the frame control header repetition.

35. A method for detecting the type of a network node; the method comprising:
receiving a first signal pattern from a first network node, the first signal pattern comprising a first attribute being indicative for the type of the first network node;
evaluating the received first attribute; and
determining the type of the first network node.

36. The method of claim 35, further comprising
receiving a second signal pattern from a second network node, the second signal pattern comprising a second attribute being indicative for the type of the second network node;
evaluating the received second attribute; and
determining the type of the second network node.

37. The method according to claim 35, further comprising
connecting to at least one of the first and the second network node for transmitting communication data depending upon the determined type of the first and of the second communication node.

38. The method according to one of the claim 35, wherein
determining the type of the first and/or of the second network node comprises one of the group consisting of evaluating a type-indicative preamble of a frame, evaluating a type-indicative flag of a frame and evaluating a type-indicative polarity sequence in the frame control header repetition.
